(19) United States
(12) Patent Application Publication
(10) Pub. No.: US 2004/0128688 A1
(43) Pub. Date: Jul. 1, 2004

(54) Method for providing advertisement VOD services for mobile communication terminal

(75) Inventor: Bae-Won Seo, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/732,107

(22) Filed: Dec. 10, 2003

(30) Foreign Application Priority Data
Dec. 28, 2002 (KR) 86055/2002

(51) Int. Cl. H04N 7/173; H04N 7/18; H04N 7/16; H04N 7/10; H04N 7/025

(52) U.S. Cl. 725/62; 725/86; 725/32; 725/75

(57) ABSTRACT

Disclosed is a method for providing advertisement VOD services to a mobile communication terminal whereby a user can receive and see advertisement VOD contents and request an ordering and payment of the corresponding product. A controller of the mobile communication terminal receives a key input for purchasing a product corresponding to a advertisement VOD content from a user while receiving the advertisement VOD content, and outputs a payment menu relating to the product. Information of a payment method selected by the user from the payment menu is transmitted to an advertisement VOD content server through a receiver report signal as a RTCP control packet. Information on the payment method is received for performing the payment process through a RTCP control packet as a response to the RTCP control packet from the advertisement VOD content server.

### PRIORITY

This application claims priority to an application entitled “METHOD FOR PROVIDING ADVERTISEMENT VOD SERVICES FOR MOBILE COMMUNICATION TERMINAL”, filed in the Korean Industrial Property Office on Dec. 28, 2002 and assigned Ser. No. 2002-86055, the contents of which are hereby incorporated by reference.

### BACKGROUND OF THE INVENTION

1. Field of the Invention

The present invention relates to multimedia services for a mobile communication terminal, and more particularly to a payment method using a mobile communication terminal.

2. Description of the Related Art

In addition to telephone functionality, current mobile communication terminals support multimedia services including a VOD (Video On Demand) service, a data communication service, GIS (Geographical Information Service) and GPS (Global Positioning System) services, etc. Thus, mobile communication terminals are complicated and diversified in terms of function, and are increasingly superior to a telephone only devices. In particular, the development of lX technologies enables high-speed communications, which allows for a remarkable extension of multimedia service functions such as a VOD service, etc.

Accordingly, many researchers are vigorously studying such multimedia services. Among them, a VOD-based advertising service shows significant revenue building potential, permitting users to receive visual information about available products and services. Moreover, current advertising trends are geared towards providing entertainment content allowing users to experience an advertisement as an enjoyable free multimedia service, thereby resulting in more successful advertising campaigns.

Accordingly, much research is being done on combining advertisements with multimedia services.

In particular, Korean Patent Publication No. 2001-105138 (“LEE”) entitled “Advertisement method for adding advertisement to images for TV broadcast, images for mobile communication terminal, or images for storage medium, and displaying the incorporated image” was disclosed by LEE, Jong-Yeol and LEE, Jong-Suk on Nov. 28, 2001. According to LEE, an advertisement is inserted in a VOD image for a mobile communication terminal or TV so that the advertisement and the VOD image are displayed together. This method provides the customer with the multimedia image combined with the advertisement. However, LEE does not disclose multimedia advertisements and instead discloses adding an advertisement to multimedia image. In addition, LEE does not disclose an ordering and payment method for a product or service corresponding to the advertisement.

Further, Korean Patent Publication No. 2001-90244 entitled (“Hong”) “Method and device for inputting product advertising information in multimedia data file for advertisement” was disclosed by Hong, Soon-Gi on Oct. 18, 2001. Hong aims to address problems in searching for a multimedia file for advertisement and performing an order, etc. In more detail, Hong provides a device and method for inputting product advertisement information, whereby product advertisement information or keywords are used to search a desired multimedia file. Hong also allows inputting basic commands for transmitting various types of orders and requests, etc., to an advertisement producer or a corresponding product seller, a broker, etc, based on the searched multimedia file. However, because the format of multimedia data used in Hong is different from the conventional formats, it is difficult to apply this method and device to a universal advertisement VOD service.

The conventional advertisement VOD service provides only corresponding advertisement contents in response to a selection of one of available VOD service contents, i.e., it does not have a function to support the purchase of the corresponding product, etc., so the advertisement is not sufficient to effectively market the product.

Similarly, an SMS (Short Message Service)-based advertising method has evoked consumer complaints due to transmitting many spam messages to many and unspecified persons, thereby also resulting in ineffective advertising. Moreover, text-based advertisements are not very attractive for advertisers due to the presentation limitations inherent in a text-only format.

### SUMMARY OF THE INVENTION

Therefore, the present invention has been made in view of the above problems, and it is an object of the present invention to provide a method and computer readable computer program for providing advertisement VOD (Video On Demand) services to a mobile communication terminal whereby a user can receive and see advertisement VOD contents, order and purchase the corresponding product, or service.

It is another object of the present invention to provide a method for providing advertisement VOD services for a mobile communication terminal whereby a seller can transmit a desired multimedia (particularly, a VOD) advertisement to a customer's mobile communication terminal, thereby allowing the customer to obtain a desired category of advertisement in his or her spare time without using other media other than the mobile communication terminal.

It is still another object of the present invention to provide a method, through the ongoing VOD service, for providing advertisement VOD services for a mobile communication terminal whereby the customer can receive multimedia advertisements instead of, conventional monotonous advertisement, thereby maximizing advertising effects of the advertiser.

It is yet another object of the present invention to provide a method for providing advertisement VOD services for a mobile communication terminal whereby the customer can receive multimedia advertisement, other than a monotonous text-based advertisement, through VOD services, resulting in customer excitement about the advertised product, sufficient to cause the customer to purchase a product, and a method for providing for the order of and payment for the purchased product.

In accordance with one aspect of the present invention, the above and other objects can be accomplished by the provision of a method for providing advertisement VOD (Video On Demand) services for a mobile communication terminal, the method comprising:

a first step of allowing a controller of the mobile communication terminal to receive a key input for purchasing a product corresponding to a advertisement VOD content from a user while the user receives the advertisement VOD content, and to output a payment menu relating to the product;

a second step of transmitting information of a payment method selected by the user from the payment menu outputted in the first step to an advertisement VOD content server through a receiver report signal as a RTCP (Real-time Transport Control Protocol) control packet; and

a third step of receiving means for performing the payment method through a RTCP control packet as a response to the RTCP control packet of the second step from the advertisement VOD content server, and then performing the payment process.

In accordance with another aspect of the present invention, there is provided a computer-readable recording medium stored with a program which allows a mobile communication terminal including a processor to implement:

a first function of allowing a controller of the mobile communication terminal to receive a key input for purchasing a product corresponding to a advertisement VOD content from a user while the user receives the advertisement VOD content, and to output a payment menu relating to the product;

a second function of transmitting information of a payment method selected by the user from the payment menu outputted by the first function to an advertisement VOD content server through a receiver report signal as a RTCP (Real-time Transport Control Protocol) control packet; and

a third function of receiving means for performing the payment method through a RTCP control packet as a response to the RTCP control packet by the second function from the advertisement VOD content server, and then performing the payment process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an exemplary configuration of a VOD service system for a mobile communication terminal according to an embodiment of the present invention.

FIG. 2 shows a configuration of an advertisement VOD service system for a mobile communication terminal according to an embodiment of present invention.

FIG. 3 shows a configuration of an RTCP control packet according to an embodiment of the present invention.

FIG. 4 shows a configuration of a payload type of a RTCP packet used for requesting the payment of charges through a receiver report of a mobile communication terminal, according to an embodiment of the present invention.

FIGS. 5a to 5d show a configuration of a response RTCP packet as a response to the RTCP packet for requesting the payment of charges of the mobile communication terminal, according to an embodiment of the present invention.

FIG. 6 is a flow chart showing the purchasing a product during the reception of an advertisement VOD.

### DETAILED DESCRIPTION OF THE PREFERRED EMBODIMENTS

Now, preferred embodiments of the present invention will be described in detail with reference to the drawings. In the following description of the present invention, a detailed description of known functions and configurations incorporated herein will be omitted when it may make the subject matter of the present invention unclear.

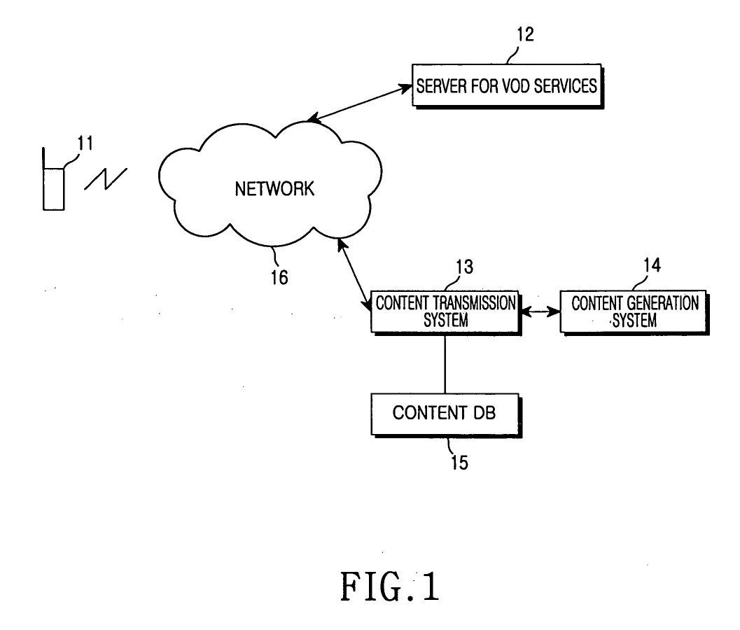

FIG. 1 is a view showing the configuration of a VOD service system for a general mobile communication terminal according to an embodiment of the present invention. The VOD service system includes a mobile communication terminal 11 capable of accessing VOD services, a mobile communication service server 12, a content generation system 14, a content transmission system 13, and a network 16. The mobile communication service server 12 manages VOD content lists and provides VOD services in a menu form to the terminal 11. The content generation system 14 generates VOD content by converting existing animated image files or by using received real-time broadcast data, and transmits the produced VOD content to the content transmission system 13. The content transmission system 13 manages VOD content in a database structure, and transmits the VOD content to the terminal 11 through a connection therebetween, while controlling the transmission. The network 16 provides a wireless Internet communication network preferably conforming to IS (International Standard)—707/2000 which is provided by a communication carrier.

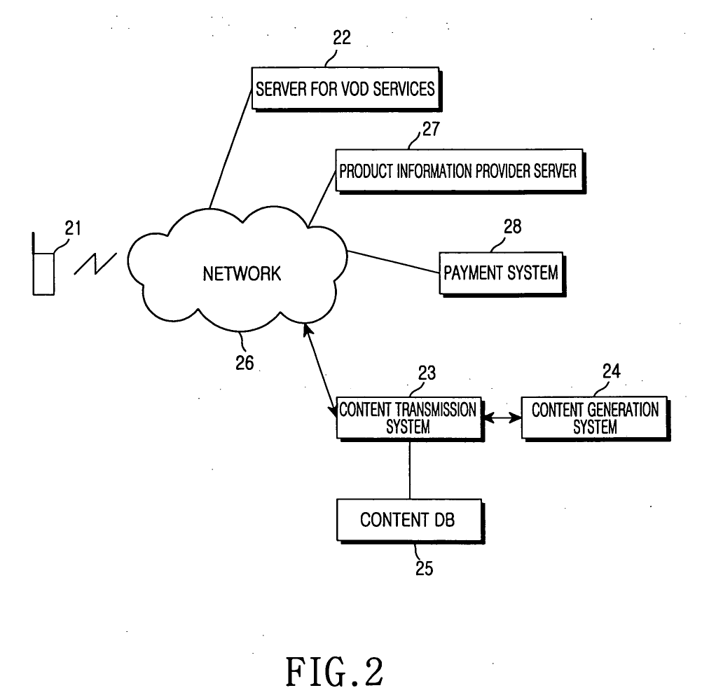

FIG. 2 is a view showing the configuration of an advertisement VOD service system for a mobile communication terminal according to the present invention. The advertisement VOD service system includes a mobile communication terminal 21 capable of using VOD services, a mobile communication service server 22, a content generation system 24, a content transmission system 23, and a network 16. The advertisement VOD service system further includes a product information provision system 27 and a payment system 28. The mobile communication service server 22 manages advertisement VOD content lists and provides advertisement VOD services in a menu form to the terminal 21. The content generation system 24 generates advertisement VOD content by converting existing animated image files or by using received real-time broadcast data, and transmits the produced VOD content to the content transmission system 23. The content transmission system 23 manages advertisement VOD content in a database structure, and transmits the VOD content to the terminal 21 through a connection therebetween, while controlling the transmission. The network 26 provides a wireless Internet communication network preferably conforming to IS (International Standard)—707/2000 which is provided by a communication carrier. The product information provision server 27 provides product information on products to be advertised. The payment system 28 performs a payment process for a product selected by the terminal's user through its advertisement VOD content.

The content transmission system 23 and the content generation system 24 are separated from each other in terms of function, but they can be incorporated into the same equipment as needed.

According to the present invention, a new payload packet for payment is defined in an RTCP (Real-time Transport Control Protocol) packet that is used as a control packet in transmitting advertisement VOD data. The present invention provides for a newly-defined payload packet providing a direct connection between the advertisement and the payment transaction. That is, in the case where, while receiving advertisement VOD broadcasts, a user requests the purchase of a product corresponding to currently-received advertisement VOD broadcast, the user is provided with information on the product and a payment method or means for the product.

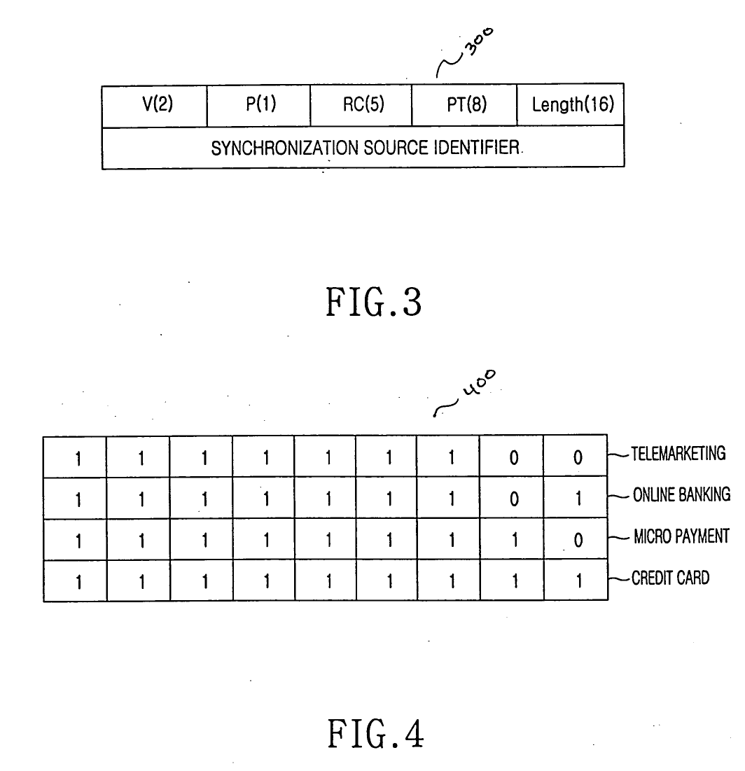

FIG. 3 is a view showing the configuration of an RTCP control packet 300 according to the embodiment of the present invention.

Generally, an RTCP is an additional protocol for maintaining QoS. A routing table protocol (RTP) engages in data transmission, but the RTCP engages in monitoring the data 20; transmission and transmitting session-related information. Thus, RTP nodes transmit the RTCP packet to each other in order to analyze the network status and report information on network congestions. Both the RTP and the RTCP operate on a UDP (User Datagram Protocol), making it difficult to guarantee QoS and reliability or of prevent transmission in an incorrect sequence. However, the RTP and the RTCP provide time-related information required for real-time transmission and also provide a information medium synchronization functions, and therefore both protocols are used in almost all recent applications, such as VOD, AOD, Internet broadcast, and video conference, etc., which use real-time information on the Internet.

The RTCP control packet used in the present invention comprises a V (Version) field of 2 bits, a P (Padding) field of 1 bit, a RC (Reception Counter) field of 5 bits, a PT (Payload Type) field of 8 bits, a length field of 16 bits, and a SSI (Synchronization Source Identifier) field of 16 bits.

In more detail, the V field represents the version of the RTP whose recent version is 2.0. The version of the RTCP packet data is the same as that of the RTP packet data.

The P field is used for constructing packets in 32-bit units. When the P field is set, it indicates that padding octets, other than the payload portion, is included in the end of the packet.

The RC field indicates the number of reception report blocks included in the corresponding packet.

The PT field indicates the RTP payload format of a profile defined in “RFC (Request for Comments) 1890”, and is analyzed by a corresponding application. The profile assigns payload types to payload formats while fixing the correlation therebetween. That is, when the PT is 0, it indicates encoding-type audio information with 800 Hz clock rate and one audio channel. There are 33 payload types currently defined. In the present invention, a new PT field is assigned for an advertisement-related payment method, and a corresponding payload type is defined. FIG. 4 shows such a new PT field.

The length field indicates the length of the RTCP packet 300. This length includes a header and a padding. The synchronization source identifier field indicates an identifier of the data source of a camera or microphone.

FIG. 4 is a view showing the configuration of a payload type of a RTCP packet 400 used for requesting the payment of charges through a receiver report of a mobile communication terminal, according to the present invention. The payload type is used to determine desired payment means for a product, after a corresponding advertisement VOD is viewed by a user.

The present invention supports four types of a payment method or means.

The four types of payment methods are a telemarketing-based payment, an online banking payment, a micro payment using a mobile communication terminal, and a credit card payment.

As shown in FIG. 4 at 400, the payload type according to the present invention is comprised of 8 bits. The upper 6 bits are all set to “1” whereas the lower 2 bits are used to designate the payment method.

In the embodiment of the present invention, “11111100” is set to the telemarketing payment, “11111101” is set to the online banking payment, “11111110” is set to the micro payment using the mobile terminal, and “11111111” is set to the credit card payment.

Because the number of payload types currently defined is 33, it is possible to set the payload type in a different manner from the above manner.

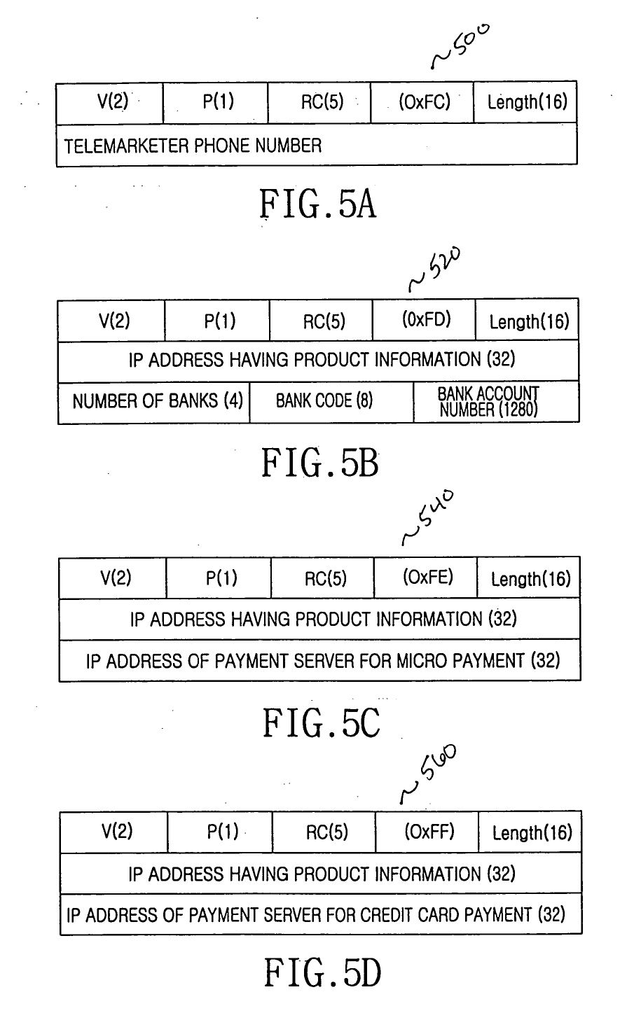

FIGS. 5a to 5d are views showing the configuration of a response RTCP packet as a response to the RTCP packet requesting the payment of charges of the mobile communication terminal, according to an embodiment of the present invention. In the packet 500 of FIG. 5a, the payload type is set as “111111 00(0xFC)” representing that the response RTCP packet is a response to the telemarketing-based payment request. In this case, the packet contains a telemarketer's phone number as concerned information. In the telemarketing method, it is possible to obtain detailed information on products by the phone, so there is no need to provide an IP address required for providing the product information.

In the packet 520 of FIG. 5b, the payload type is set as “11111101(0xFD)” representing that the response RTCP packet is a response to the online banking payment request. In this case, the packet contains, as concerned information, a 32-bit IP address field for providing product information, a 4-bit number-of-banks field, an 8-bit bank code field, and a bank account number field.

In the packet of 540 of FIG. 5c, the payload type is set as “11111110(0xFE)” representing that the response RTCP packet is a response to the micro payment request using the mobile communication terminal. In this case, the packet contains, as concerned information, a 32-bit field representing an IP address which provides product information, and a 32-bit field representing an IP address of a payment server for micro payment using the mobile communication terminal. After receiving the IP address of the payment server for micro payment, the mobile communication terminal terminates the current streaming and tries to access the IP address of the payment server for micro payment.

In the packet 560 of FIG. 5d, the payload type is set as “11111111(0xFF)” representing that the response RTCP packet is a response to the payment request using the credit card. In this case, the packet contains, as concerned information, a 32-bit field representing an IP address which provides product information, and a 32-bit field representing an IP address of a payment server for credit card payment. After receiving the IP address of the payment server for credit card payment, the mobile communication terminal terminates the current streaming and tries to access the IP address of the payment server for credit card payment.

The IP address field included in the packet is currently composed of 32 bits, but, when an IPv6 (Internet Protocol Version 6) is available in the future, the corresponding number of bits can be increased in accordance with IPv6 or any other future protocol or standard.

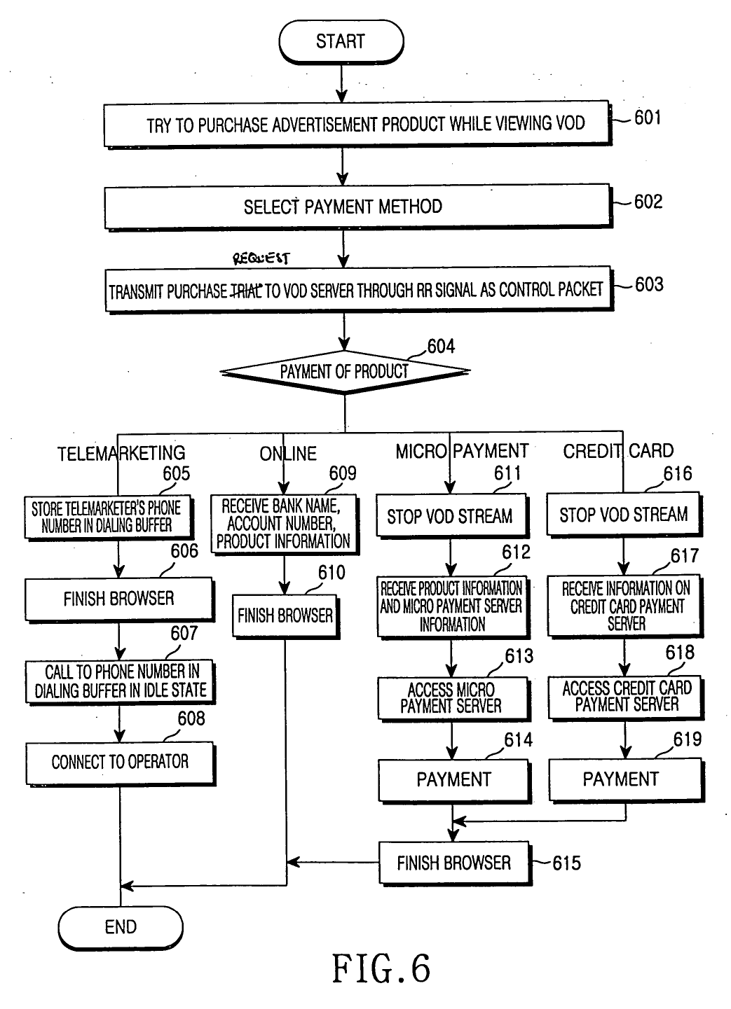

FIG. 6 is a flow chart showing the procedure of a method for purchasing a product during the reception of an advertisement VOD. A user receives an advertisement VOD service through a mobile communication terminal capable of receiving VOD services (not shown). While receiving and viewing the advertisement VOD, the user tries to purchase a product corresponding to the advertisement VOD (601). Such an advertisement VOD broadcast can increase the number of viewers by adopting a payment method in which the advertiser pays the charges of the data packet service.

Then, for purchasing the product, it is determined which type of payment method is used for the payment of charges of the product (602). The mobile communication terminal transmits a request for purchasing the product to the VOD server through a receiver report signal as a control packet (603). The mobile communication terminal, then performs the payment process (604), which includes receiving a response about the payment method and transacting the payment.

There are four types of payment methods, i.e., telemarketing-based payment, online banking payment, the micro payment using the mobile terminal, and the credit card payment, as illustrated in steps (605) to (619).

In the case where telemarketing-based payment is selected as the payment method, the telemarketer's phone number is stored in a dialing buffer of the terminal (605). The terminal finishes a browser for receiving the VOD service (606), and tries to establish a phone connection using the phone number stored in the dialing buffer in a phone idle state (607). When the phone connection is established, the user purchases the product through consultation with the telemarketer on the phone (608).

In the case where online banking is selected as the payment method, the terminal receives information required for the online banking, such as an IP address where there is the product information, a bank name, and an account number (609). The mobile communication terminal finishes the browser currently receiving the VOD service (610), and performs the payment process through the bank.

In the case where micro payment using the mobile communication terminal is selected as the payment method, the terminal finishes the VOD streaming (611), and receives the IP address where there is the product information and the IP address of a payment server for micro payment (612). Then, the terminal gains access to the server for micro payment (613), performs a payment process (614), and finishes the browser (615).

In the case where credit card payment is used as the payment method, the terminal finishes the VOD streaming (616), and receives the IP address where there is the product information and the IP address of a payment server for credit card payment (617). Then, the terminal gains access to the server for credit card payment (618), performs a payment process (619), and finishes the browser (615).

As apparent from the above description, the present invention has advantages in that a seller can transmit a desired advertisement to a customer using multimedia (particularly, a VOD) transmitted to the customer's mobile communication terminal, while the customer can obtain a desired category of advertisement in a spare time through the mobile communication terminal without using other media.

In addition, it is possible to provide, thorough ongoing VOD service, the customer with multimedia advertisements, instead of conventional monotonous advertisement, thereby maximizing advertising effects of the advertiser.

Further, it is possible to provide the customer, thorough VOD services with multimedia advertisements, other than a monotonous text-based advertisements, whereby the customer is excited about the advertisement product sufficiently to cause the customer to purchase a product, and to provide a method for the order of and payment for the purchase product.

The advertisement VOD service method according to the present invention can be embodied as a program, and the program can be stored in a recording medium, such as a CD ROM, a RAM, a floppy disk, a hard disk, an optical magnetic disk, etc., in the computer-readable format.

Although the preferred embodiments of the present invention have been disclosed for illustrative purposes, those skilled in the art will appreciate that various modifications, additions and substitutions are possible, without departing from the scope of the invention.

What is claimed is:

1. A method for providing advertisement VOD (Video On Demand) services for a mobile communication terminal, the method comprising:
transmitting an advertisement VOD to the mobile communication terminal;
receiving a request from the mobile communication terminal for purchasing a product corresponding to the transmitted advertisement VOD,;
receiving a first RTCP (Real-time Transport Control Protocol) control packet including information corresponding to a payment method selected from a payment menu;
transmitting a second RTCP control packet, the second RTCP control packet including information for performing a payment according to the selected payment method; and
performing a payment process.

2. A method as set forth in claim 1, wherein the first and second RTCP control packets each includes a V (Version) field for representing version information, a P (Padding) field for representing padding information, an RC (Reception Counter) field for representing reception count information, a PT (Payload Type) field for representing a payload type, and a length field for representing packet length information, and
wherein at least one bit of the PT field is used to define a payment method.

3. A method as set forth in claim 2, wherein said payment methods include at least one of a telemarketing-based payment method, an online banking payment method, a micro payment based payment method, and a credit card based payment method.

4. The method as set forth in claim 3, wherein if the selected payment method is the telemarketing-based payment method, the second RTCP control packet further includes a telemarketer phone number contained in a telemarketer phone number field .

5. A method as set forth in claim 4 further comprising:
storing the transmitted telemarketer phone number in a phone number dialing buffer of the mobile communication terminal;
terminating the advertisement VOD being received by the mobile communication terminal; and
performing the payment process by establishing a telephone call between the mobile communication terminal and a telemarketer using the stored telemarketer phone number.

6. The method as set forth in claim 3, wherein if the selected payment method is the online banking payment method, the second RTCP control packet further includes an IP address field corresponding to information about the product, a number-of-banks field corresponding to information on the number of banks for online banking, a bank-code field corresponding to bank codes for online banking, and an account number corresponding to a bank account for use in purchasing the product.

7. A method as set forth in claim 6 further comprising:
terminating the advertisement VOD being received by the mobile communication terminal; and
performing the payment process by establishing an online transaction between the mobile communication terminal and a bank using the transmitted account number.

8. The method as set forth in claim 3, wherein if the selected payment method is the micro payment method the second RTCP control packet further includes an IP address field for representing information on the product and an IP address field for representing a micro payment server.

9. A method as set forth in claim 8, further comprising:
terminating the advertisement VOD being received by the mobile communication terminal; and
performing the payment process by establishing a micro payment transaction between the mobile communication terminal and the micro payment server using the micro payment IP address.

10. The method as set forth in claim 3, wherein, if the selected payment method is the credit card payment method, the second RTCP packet further includes an IP address field for representing information on the product and an IP address field for representing the IP address of a credit card payment server.

11. The method as set forth in claim 10, wherein the third step includes:
terminating the advertisement VOD being received by the mobile communication terminal; and
performing the payment process by establishing a micro payment transaction between the mobile communication terminal and the micro payment server using the micro payment IP address.

12. A product of manufacture comprising a computer-readable storage medium, the computer-readable storage medium further comprising computer-readable program code for performing the following:
transmitting an advertisement VOD to the mobile communication terminal;
receiving a request from the mobile communication terminal for purchasing a product corresponding to the transmitted advertisement VOD;
receiving a first RTCP control packet including information corresponding to a payment method selected from a payment menu;
transmitting a second RTCP control packet, the second RTCP control packet including information for performing a payment according to the selected payment method; and
performing a payment process.

13. A method for providing advertisement VOD (Video On Demand) services for a mobile communication terminal, the method comprising:
transmitting an advertisement VOD to the mobile communication terminal;
receiving at a controller of the mobile communication terminal a key input request for purchasing a product corresponding to the transmitted advertisement VOD;
outputting a payment menu relating to the product;
transmitting to an advertisement VOD content server through a receiver report signal a first RTCP (Real-time Transport Control Protocol) control packet including information corresponding to a payment method selected from the payment menu; receiving from the advertisement VOD content server a second RTCP control packet, the second RTCP control packet including information for performing a payment process according to the selected payment method; and
performing the payment process.

14. The method as set forth in claim 13, wherein the first and second RTCP control packets each includes a V (Version) field for representing version information, a P (Padding) field for representing padding information, an RC (Reception Counter) field for representing reception count information, a PT (Payload Type) field for representing a payload type, and a length field for representing packet length information, wherein at least one bit of the PT field is used to define a payment method.

15. The method as set forth in claim 14, wherein said payment method includes at least one of a telemarketing-based payment method, an online banking payment method, a micro payment based payment method, and a credit card based payment method.

16. The method as set forth in claim 15, wherein if the selected payment method is the telemarketing-based payment method, the second RTCP control packet further includes a telemarketer phone number contained in a telemarketer phone number field.

17. The method as set forth in claim 16 further comprising the steps of:
receiving through a RTCP control packet a telemarketer's phone number;
storing the received telemarketer phone number in a phone number dialing buffer of the mobile communication terminal;
terminating the advertisement VOD; and
performing the payment process by establishing a telephone call between the mobile communication terminal and a telemarketer using the stored telemarketer phone number.

18. The method as set forth in claim 15, wherein if the selected payment method is the online banking payment method, the second RTCP control packet further includes an IP address field corresponding to information about the product, a number-of-banks field corresponding to information on the number of banks for online banking, a bank-code field corresponding to bank codes for online banking, and an account number corresponding to a bank account for use in purchasing the product.

19. The method as set forth in claim 18 further comprising the steps of:
receiving information on the product and a bank account number;
terminating the advertisement VOD; and
performing the payment process by establishing an online transaction between the mobile communication terminal and a bank using the transmitted bank account number.

20. The method as set forth in claim 15, wherein if the selected payment method is the micro payment method the second RTCP control packet further includes an IP address field for representing information on the product and an IP address field for representing a micro payment server.

21. The method as set forth in claim 20, further comprising the steps of:
terminating the advertisement VOD;
receiving information on the product and an IP address of the payment server for micro payment; and
performing the payment process by establishing a micro payment transaction between the mobile communication terminal and the micro payment server using the micro payment IP address.

22. The method as set forth in claim 15, wherein, if the selected payment method is the credit card payment method, the second RTCP packet further includes an IP address field for representing information on the product and an IP address field for representing the IP address of a credit card payment server.

23. The method as set forth in claim 22, further including the steps of:
terminating the advertisement VOD being received by the mobile communication terminal; and
performing the payment process by establishing a micro payment transaction between the mobile communication terminal and the micro payment server using the micro payment IP address.

24. A mobile communication terminal having computer-readable storage medium, the computer-readable storage medium having computer-readable program code for performing the following steps of:
receiving at a controller of the mobile communication terminal a key input for purchasing a product corresponding to a advertisement VOD content from a user while the user receives an advertisement VOD content;
outputting by the controller a payment menu relating to the product;
transmitting to an advertisement VOD content server through a receiver report signal as a RTCP (Real-time Transport Control Protocol) control packet information of a payment method selected by the user from a payment menu output by the controller; receiving information for performing the payment method through a RTCP control packet as a response to the RTCP control packet by the second function from the advertisement VOD content server; and
performing the payment process.
